(19) United States
(12) Patent Application Publication
(10) Pub. No.: US 2012/0163608 A1
(43) Pub. Date: Jun. 28, 2012

(54) ENCODER, ENCODING METHOD, AND COMPUTER-READABLE RECORDING MEDIUM STORING ENCODING PROGRAM

(75) Inventors: Yohei KISHI, Kawasaki (JP); Masanao Suzuki, Kawasaki (JP); Miyuki Shirakawa, Fukuoka (JP); Yoshiteru Tsuchinaga, Fukuoka (JP)

(73) Assignee: Fujitsu Limited, Kawasaki-shi (JP)

(21) Appl. No.: 13/311,682

(22) Filed: Dec. 6, 2011

(30) Foreign Application Priority Data
Dec. 28, 2010 (JP) 2010-293284

(51) Int. Cl. H04R 5/00

(52) U.S. Cl. 381/23

(57) ABSTRACT

An encoder includes, a degree-of-importance calculating unit that calculates a degree of importance of each of a first number of signals included in input signals; a signal converting unit that converts the first number of signals included in the input signals into a second number of signals; a degree-of-importance converting unit that converts a first number of degrees of importance, a number of which is equal to the first number of signals, calculated by the degree-of-importance calculating unit into a second number of degrees of importance, a number of which is equal to the second number of signals; a number-of-bits determining unit that determines a number of bits for use in quantizing each of the second number of signals obtained by the conversion performed by the signal converting; and a quantizing unit that quantizes each of the second number.

### CROSS-REFERENCE TO RELATED APPLICATION

This application is based upon and claims the benefit of priority of prior Japanese Patent Application No. 2010-293284, filed on Dec. 28, 2010, the entire contents of which are incorporated herein by reference.

### FIELD

Embodiments disclosed herein relate to an encoder, an encoding method, and a computer-readable recording medium storing an encoding program.

### BACKGROUND

MPEG surround (MPS) coding is a coding technique standardized by the International Organization for Standardization (ISO) and the International Electrotechnical Commission (IEC). The MPS coding realizes both reproduction compatibility with existing stereo and mono decoders and 5.1-channel surround.

An MPS encoder according to the related art that performs MPS coding will be described. FIG. 16 is a first diagram illustrating a configuration of an MPS encoder according to the related art. As illustrated in FIG. 16, an MPS encoder 10 includes reverse-one-to-two (R-OTT) units 11a to 11c and a reverse-two-to-three (R-TTT) unit 12. The MPS encoder 10 also includes a bit allocation deciding unit 13, quantizing units 14a to 14d, and a multiplexing unit 15.

A case of encoding 5.1 multichannel signals will be described here. The multichannel signals include an FL signal, an SL signal, an FR signal, an SR signal, a C signal, and an LFE signal.

The FL signal corresponds to sound output from a front left speaker. The SL signal corresponds to sound output from a rear left speaker. The FR signal corresponds to sound output from a front right speaker. The SR signal corresponds to sound output from a rear right speaker. The C signal corresponds to sound output from a center speaker. The LFE signal corresponds to sound output from a speaker dedicated to low-pitched audio frequencies, such as a subwoofer.

The R-OTT units 11a to 11c are processing units that downmix multichannel signals. The R-OTT unit 11a downmixes the FL signal and the SL signal and outputs the downmixed signal to the R-TTT unit 12. The R-OTT unit 11a also outputs a residual signal to the quantizing unit 14a and outputs spatial information to the multiplexing unit 15. Here, the residual signal corresponds to a difference between original information and information lost in downmixing. The spatial information corresponds to an energy ratio of signals to be downmixed or a correlation between the signals.

The R-OTT unit 11b downmixes the C signal and the LFE signal and outputs the downmixed signal to the R-TTT unit 12. The R-OTT unit 11b also outputs spatial information to the multiplexing unit 15.

The R-OTT unit 11c downmixes the FR signal and the SR signal and outputs the downmixed signal to the R-TTT unit 12. The R-OTT unit 11c also outputs a residual signal to the quantizing unit 14d and outputs spatial information to the multiplexing unit 15.

The R-TTT unit 12 is a processing unit that further downmixes the signals that have been downmixed by the R-OTT units 11a to 11c. The R-TTT unit 12 outputs the downmixed signals to the quantizing unit 14b and outputs a residual signal to the quantizing unit 14c. Meanwhile, the R-TTT unit 12 generates two signals by downmixing the signals from the R-OTT units 11a to 11c. That is, the R-TTT unit 12 downmixes three signals to generate two signals and outputs the two signals to the quantizing unit 14b.

The bit allocation deciding unit 13 is a processing unit that controls bit allocation of the quantizing units 14a to 14d. The bit allocation of the quantizing units 14a to 14d are set in advance. The bit allocation deciding unit 13 controls the bit allocation of the quantizing units 14a to 14d based on the set bit allocation. Meanwhile, for example, Japanese Laid-open Patent Publication No. 7-175499 discloses an example of performing such control.

The quantizing units 14a to 14d are processing units that quantize signals in accordance with the bit allocation controlled by the bit allocation deciding unit 13. For example, when the bit allocation is set to n bits, the quantizing units 14a to 14d quantize a signal into an n-bit signal.

The quantizing unit 14a quantizes the residual signal acquired from the R-OTT unit 11a and outputs the quantized information to the multiplexing unit 15. The quantizing unit 14b quantizes each of the two signals acquired from the R-TTT unit 12 and outputs the quantized information to the multiplexing unit 15. The quantizing unit 14c quantizes the residual signal acquired from the R-TTT unit 12 and outputs the quantized information to the multiplexing unit 15. The quantizing unit 14d quantizes the residual signal acquired from the R-OTT unit 11c and outputs the quantized information to the multiplexing unit 15.

The multiplexing unit 15 is a processing unit that multiplexes the pieces of information acquired from the quantizing units 14a to 14d and outputs the multiplexed information. The aforementioned configuration illustrated in FIG. 16 includes components defined in the ISO/IEC 23003-1:2007 standard.

As described above, the MPS encoder 10 quantizes multichannel signals after fixing the bit allocation of the quantizing units 14a to 14d in advance. However, when the MPS encoder 10 receives a signal requiring a large number of quantization bits, the number of bits for use in quantization may run short.

Now, an example of a relation between the number of bits required in quantization and the number of fixed allocation bits will be described. FIG. 17 is a diagram illustrating a relation between the number of bits required in quantization and the number of fixed allocation bits. A vertical axis of FIG. 17 represents the number of bits. Additionally, references 1a, 1b, 1c, and 1d in FIG. 17 represent the numbers of bits allocated for the quantizing units 14a to 14d in a fixed manner, respectively, whereas references 2a, 2b, 2c, and 2d represent the numbers of bits required by the quantizing units 14a to 14d to quantize a signal, respectively.

In the example illustrated in FIG. 17, since the number of bits required in quantization does not exceed the number of bits allocated for the quantizing units 14a, 14b, and 14d in the fixed manner, the quantized signal does not deteriorate even if the signal is quantized. On the other hand, the number of bits allocated for the quantizing unit 14c in the fixed manner is less than the number of bits required in quantization. Accordingly, when a signal is quantized, necessary information does not fit into the fixed allocation bits and, as a result, the signal deteriorates because of quantization.

To address the problem illustrated in FIG. 17, a technique is provided that dynamically changes the number of bits set for a quantizing unit in accordance with a degree of importance of a signal. By dynamically changing the number of bits in this way, a circumstance where the number of bits set for the quantizing unit becomes less than the number of bits required is quantization is avoided and, thus, deterioration of the signal is prevented.

FIG. 18 is a second diagram illustrating a configuration of an MPS encoder according to the related art. As illustrated in FIG. 18, an MPS encoder 20 includes R-OTT units 21a to 21c, an R-TTT unit 22, a degree-of-importance calculating unit 23, a bit allocation deciding unit 24, quantizing units 25a to 25d, and a multiplexing unit 26.

The R-OTT units 21a to 21c are similar to the R-OTT units 11a to 11c illustrated in FIG. 16. The R-TTT unit 22 is also similar to the R-TTT unit 12 illustrated in FIG. 16. Additionally, the multiplexing unit 26 is similar to the multiplexing unit 15 illustrated in FIG. 16.

The degree-of-importance calculating unit 23 is a processing unit that acquires residual signals and downmixed signals from the R-OTT units 21a to 21c and the R-TTT unit 22 and calculates a degree of importance of each signal. More specifically, the degree-of-importance calculating unit 23 calculates a degree of importance of each of the residual signal output from the R-OTT unit 21a, the residual signal output from the R-OTT unit 21c, and two downmixed signals and the residual signal output from the R-TTT unit 22. For example, the degree-of-importance calculating unit 23 calculates the degree of importance using perceptual entropy. The degree-of-importance calculating unit 23 outputs the degree of importance of each signal to the bit allocation deciding unit 24.

The bit allocation deciding unit 24 is a processing unit that decides bit allocation of the quantizing units 25a to 25d in accordance with the degrees of importance. More specifically, the bit allocation deciding unit 24 increases bit allocation of a quantizing unit that is to quantize a signal having a high degree of importance, whereas the bit allocation deciding unit 24 decreases bit allocation of other quantizing units. The bit allocation deciding unit 24 controls the bit allocation of the quantization units 25a to 25d based on the decided bit allocation.

The quantizing units 25a to 25d are processing units that quantize signals in accordance with the bit allocation controlled by the bit allocation deciding unit 24. Meanwhile, signals quantized by the quantizing units 25a to 25d are similar to those quantized by the quantizing units 14a to 14d illustrated in FIG. 16. An example of performing such control is disclosed in, for example, Japanese Laid-open Patent Publication (Translation of PCT Application) No. 2007-531915.

As described above, in accordance with the MPS encoder 20 illustrated in FIG. 18, the bit allocation deciding unit 24 adjusts the bit allocation in accordance with the degrees of importance to dynamically change the bit allocation of each of the quantizing units 25a to 25d. Accordingly, a circumstance where the number of bits set for each of the quantizing units 25a to 25d becomes less than the number of bits required in quantization is avoided and, thus, deterioration of the signal because of quantization can be prevented.

### SUMMARY

In accordance with an aspect of the embodiments, an encoder includes, a degree-of-importance calculating unit that calculates a degree of importance of each of a first number of signals included in input signals; a signal converting unit that converts the first number of signals included in the input signals into a second number of signals; a degree-of-importance converting unit that converts a first number of degrees of importance, a number of which is equal to the first number of signals, calculated by the degree-of-importance calculating unit into a second number of degrees of importance, a number of which is equal to the second number of signals; a number-of-bits determining unit that determines a number of bits for use in quantizing each of the second number of signals obtained by the conversion performed by the signal converting unit based on the second number of degrees of importance obtained by the conversion performed by the degree-of-importance converting unit; and a quantizing unit that quantizes each of the second number of signals based on a result determined by the number-of-bits determining unit.

The object and advantages of the invention will be realized and attained by at least the features, elements, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

These and/or other aspects and advantages will become apparent and more readily appreciated from the following description of the embodiments, taken in conjunction with the accompanying drawing of which:

FIG. 1 is a diagram illustrating a configuration of an MPS encoder according to an embodiment;

FIG. 2 is a diagram illustrating a configuration of a frequency signal FL (k, n);

FIG. 3 is a diagram illustrating a configuration of a signal converting unit;

FIG. 4 is a diagram illustrating a data structure of a quantization table;

FIG. 5 is a diagram for describing processing of a degree-of-importance calculating unit;

FIG. 6 is a diagram illustrating a configuration of a degree-of-importance converting unit;

FIG. 7 is a diagram illustrating a configuration of an R-OTT-P unit;

FIG. 8 is a diagram illustrating a configuration of an R-TTT-P unit;

FIG. 9 is a diagram illustrating a relation between bit allocation and a degree of importance;

FIG. 10 is a diagram illustrating a data structure of a CLD quantization table;

FIG. 11 is a diagram illustrating a data structure of an ICC quantization table;

FIG. 12 is a diagram illustrating a data structure of a CPC quantization table;

FIG. 13 is a diagram illustrating an example of a format of MPEG-2 ADTS;

FIG. 14 is a flowchart illustrating a processing procedure performed by an MPS encoder according to an embodiment;

FIG. 15 is a diagram illustrating a hardware configuration of a computer constituting the MPS encoder according to the embodiment;

FIG. 16 is a first diagram illustrating a configuration of an MPS encoder according to the related art;

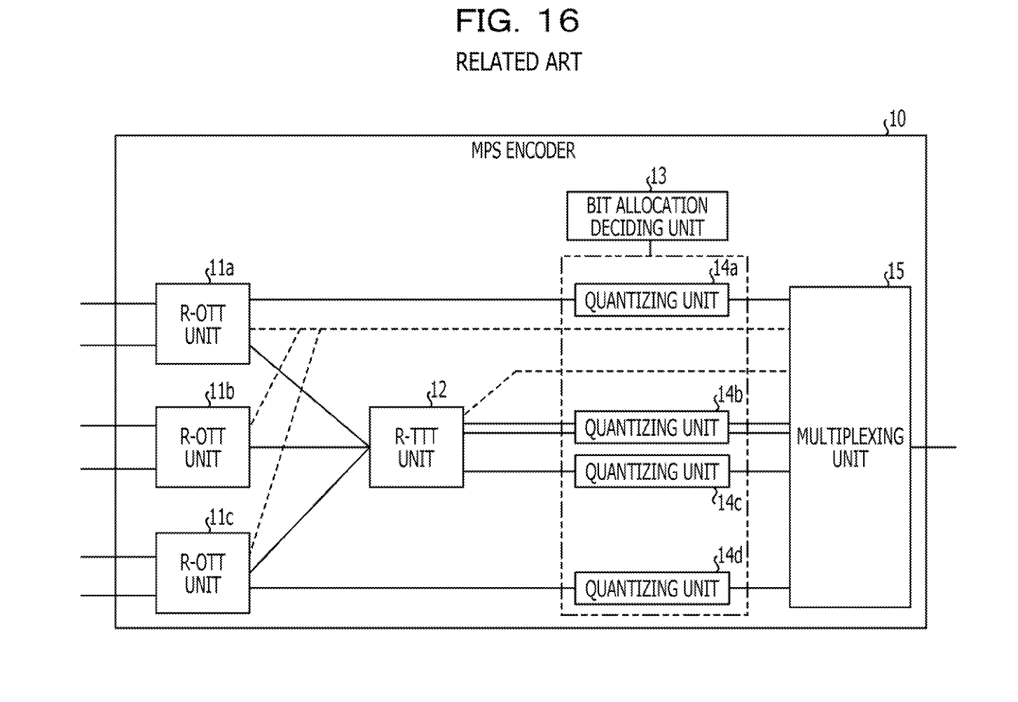

FIG. 17 is a diagram illustrating a relation between the number of bits required in quantization and the number of bits allocated in a fixed manner;

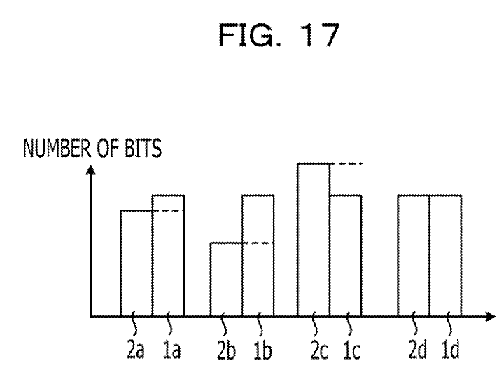

FIG. 18 is a second diagram illustrating a configuration of an MPS encoder according to the related art; and

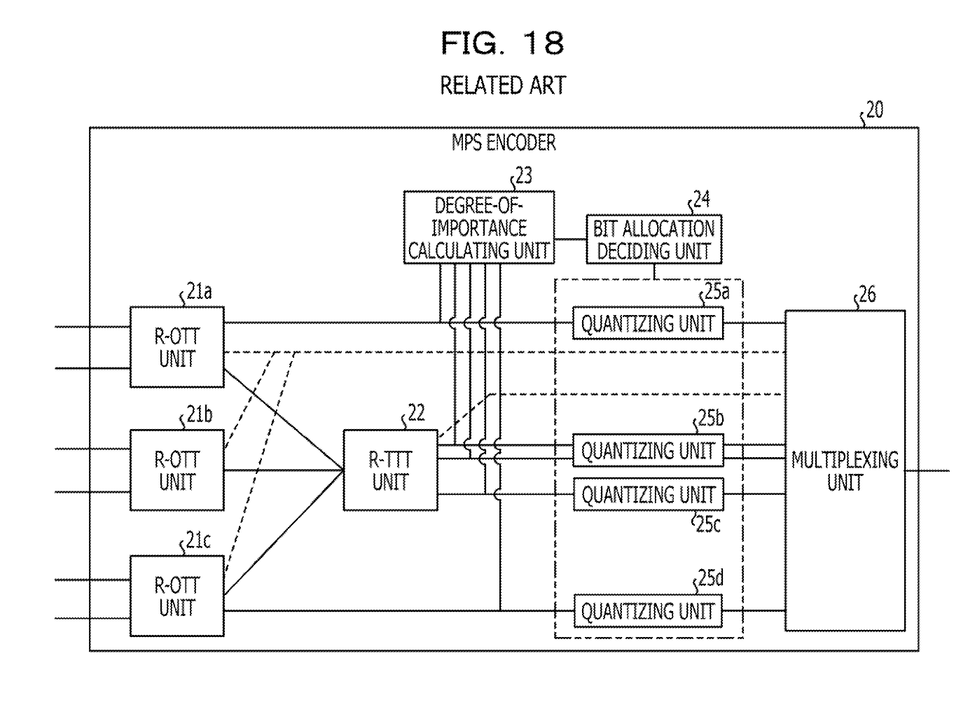

FIG. 19 is a diagram for describing a problem in the related art.

### DESCRIPTION OF EMBODIMENTS

A problem newly found in the related art is that a degree of importance of each signal included in multichannel signals is not correctly calculated and sound quality deteriorates.

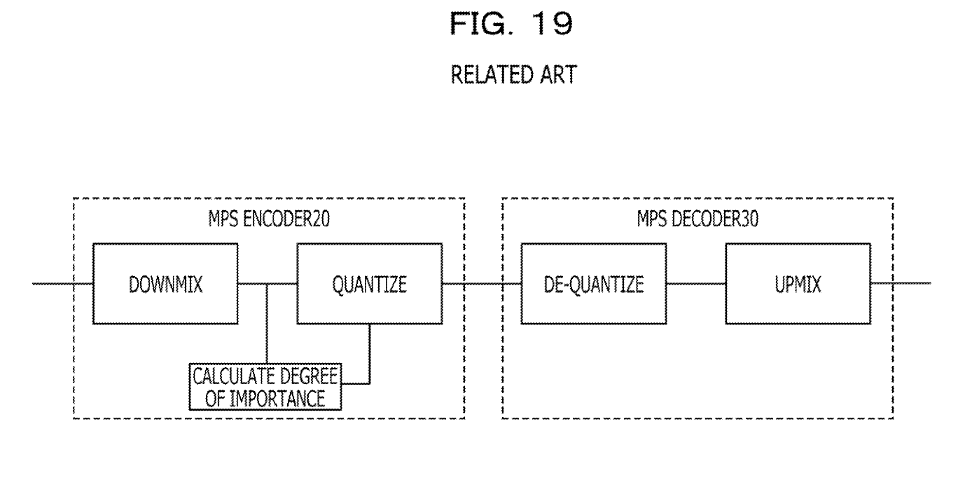

FIG. 19 is a diagram for describing a problem of the related art. FIG. 19 illustrates a case where an MPS decoder 30 decodes information output from an MPS encoder 20. The MPS encoder 20 downmixes 6-channel signals included in multichannel signals to generate 5-channel signals and quantizes the generated 5-channel signals. The MPS encoder 20 calculates a degree of importance of each of the 5-channel downmixed signals and quantizes the signal using the number of bits set in accordance with the degree of importance.

The MPS decoder 30 acquires information from the MPS encoder 20 and de-quantizes the acquired information. The MPS decoder 30 then performs upmixing to convert the 5-channel signals into 6-channel signals.

The degree of importance calculated by the MPS encoder 20 is based on the 5-channel downmixed signals. However, the 6-channel signals are ultimately output from the MPS decoder 30. For this reason, the degrees of importance of the signals calculated by the MPS encoder 20 and the signals output from the MPS decoder 30 may lack a correspondence and the degrees of importance may be calculated inaccurately.

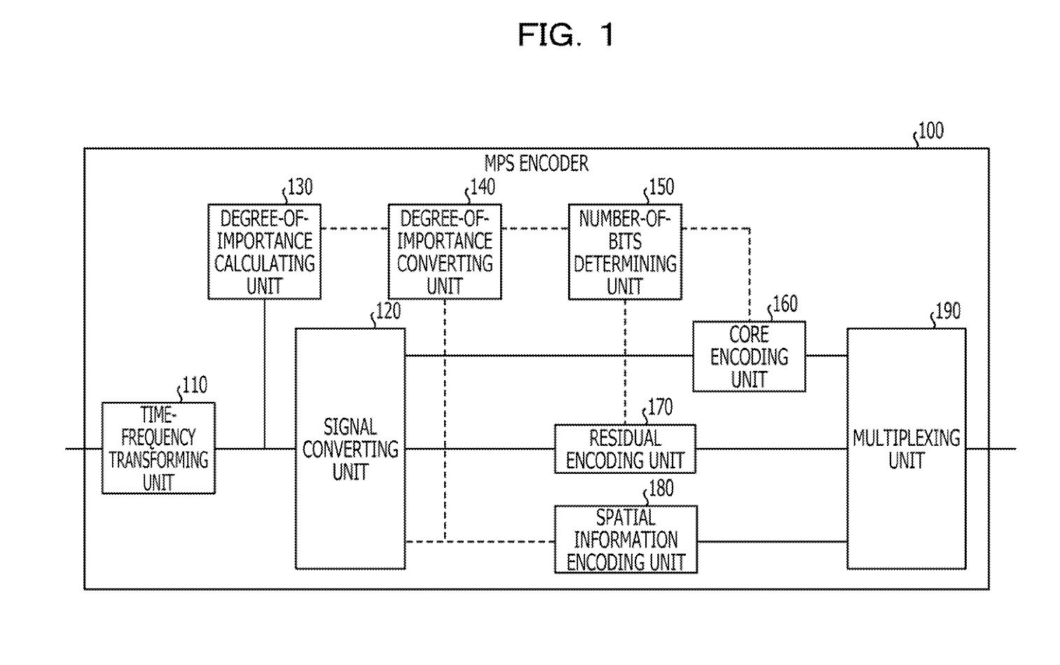

An example of a configuration of an MPS encoder according to an embodiment will be described. This MPS encoder serves as an example of an encoder. FIG. 1 is a diagram illustrating a configuration of an MPS encoder according to the embodiment. As illustrated in FIG. 1, an MPS encoder 100 includes a time-frequency transforming unit 110, a signal converting unit 120, a degree-of-importance calculating unit 130, and a degree-of-importance converting unit 140. The MPS encoder 100 also includes a number-of-bits determining unit 150, a core encoding unit 160, a residual encoding unit 170, spatial information encoding unit 180, and a multiplexing unit 190.

The time-frequency transforming unit 110 is a processing unit that acquires a time-domain input signal and transforms this input signal into a frequency-domain signal. Multichannel signals are input to the time-frequency transforming unit 110. In a 5.1-channel surround system, the multichannel signals include an FL signal, an SL signal, an FR signal, an SR signal, a C signal, and an LFE signal.

The time-frequency transforming unit 110 transforms the input signal into the frequency signal using, for example, a quadrature mirror filter (QMF) filter bank represented by Equation (1). In the representation of the QMF exponential function of Equation (1), j denotes an imaginary unit, n denotes a natural number for the time domain (0≦n<128), and k denotes a natural number for the frequency domain (0≦k<64).

$$QMF ( k , n ) = exp [ j \frac{π}{128} ( k + 0.5 ) ( 2 n + 1 ) ] \qquad ( 1 )$$

Suppose that the FL signal, the SL signal, the FR signal, the SR signal, the C signal, and the LFE signal included in the input signals are denoted as FL(n), SL(n), FR(n), SR(n), C(n), and LFE(n), respectively.

The time-frequency transforming unit 110 transforms the time-domain signals FL(n), SL(n), and FR(n) into the frequency-domain signals FL(k, n), SL(k, n), and FR(k, n) using Equation (1), respectively. Similarly, the time-frequency transforming unit 110 transforms the time-domain signals SR(n), C(n), and LFE(n) into the frequency-domain signals SR(k, n), C(k, n), and LFE(k, n), respectively.

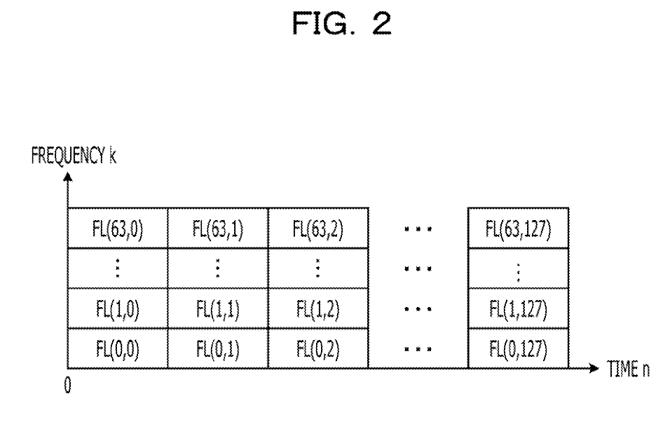

For example, a configuration of the signal FL(k, n) will be described. FIG. 2 is a diagram illustrating a configuration of the signal FL(k, n). A vertical axis of FIG. 2 represents frequency, whereas a horizontal axis thereof represents time. As illustrated in FIG. 2, the signal FL (k, n) includes 128×64 pieces of data resulting from dividing the time n into sections 0 to 127 and dividing the frequency k into sections 0 to 63. Configurations of other frequency signals SL(k, n), FR(k, n), SR(k, n), C(k, n), and LFE(k, n) are similar to that illustrated in FIG. 2.

The time-frequency transforming unit 110 outputs the frequency signals FL(k, n), SL(k, n), FR(k, n), SR(k, n), C(k, n), and LFE(k, n) to the signal converting unit 120 and the degree-of-importance calculating unit 130.

The signal converting unit 120 is a processing unit that downmixes the frequency signals including a plurality of signals. The signal converting unit 120 generates downmixed signals, residual signals, and spatial information by downmixing the frequency signals. The downmixed signal corresponds to an integrated signal of the signals included in the frequency signals. The residual signal corresponds to a difference between original information and information lost in downmixing. The spatial information corresponds to an energy ratio or correlation of signals to be downmixed.

The signal converting unit 120 outputs the downmixed signals to the core encoding unit 160. The signal converting unit 120 also outputs the residual signals to the residual encoding unit 170. Additionally, the signal converting unit 120 outputs the spatial information to the degree-of-importance converting unit 140 and the spatial information encoding unit 180.

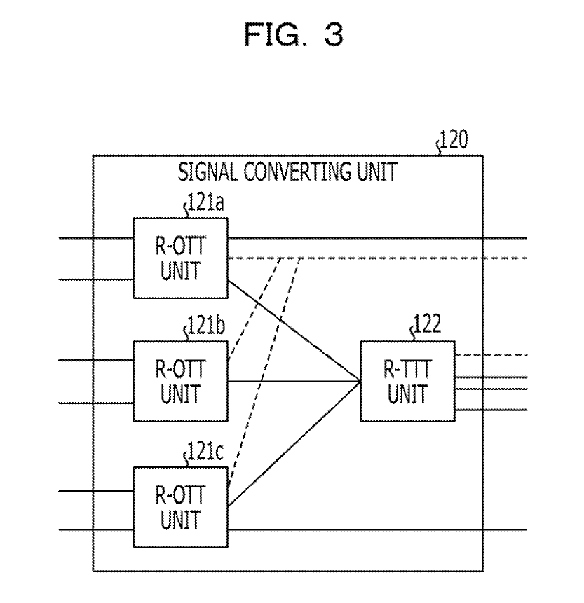

An example of a configuration of the signal converting unit 120 will now be described. FIG. 3 is a diagram illustrating a configuration of the signal converting unit 120. As illustrated in FIG. 3, the signal converting unit 120 includes R-OTT units 121a to 121c and an R-TTT unit 122.

Each of the R-OTT units 121a to 121c is a processing unit that downmixes 2-channel signals into one signal.

First, the R-OTT unit 121a will be described. The R-OTT unit 121a generates a downmixed signal, a residual signal, and spatial information based on the frequency signals FL(k, n) and SL(k, n). The R-OTT unit 121a outputs the downmixed signal to the R-TTT unit 122. The R-OTT unit 121a also outputs the residual signal to the residual encoding unit 170. Additionally, the R-OTT unit 121a outputs the spatial information to the degree-of-importance converting unit 140 and the spatial information encoding unit 180.

More specifically, the R-OTT unit 121a generates a downmixed signal L′(k, n) by downmixing the frequency signals FL(k, n) and SL(k, n). The R-OTT unit 121a also extracts, as the residual signal, a signal corresponding to a difference between the downmixed signal L′(k, n) and the frequency signals FL(k, n) and SL(k, n). The residual signal extracted by the R-OTT unit 121a is denoted as a residual signal resOTT1(k, n).

The spatial information generated by the R-OTT unit 121a includes a channel level difference (CLD) and an inter channel correlation (ICC). Processing for calculating the CLD and the ICC performed by the R-OTT unit 121a will now be described sequentially.

First, the processing for calculating the CLD performed by the R-OTT unit 121a will be described. The R-OTT unit 121a determines an autocorrelation of the signal FL(k, n) and an autocorrelation of the signal SL(k, n) to determine the CLD based on each of the determined autocorrelations.

The R-OTT unit 121a determines the autocorrelation eFL of the signal FL(k, n) using Equation (2). The R-OTT unit 121a also determines the autocorrelation eSL of the signal SL(k, n) using Equation (3). After determining the autocorrelation eFL and the autocorrelation eSL, the R-OTT unit 121a determines the CLD using Equation (4).

$$\begin{matrix}{e}_{FL} ( k ) = {\sum }_{n = 0}^{N - 1} {\vert FL ( k , n ) \vert}^{2} & ( 2 ) \\ {e}_{SL} ( k ) = {\sum }_{n = 0}^{N - 1} {\vert SL ( k , n ) \vert}^{2} & ( 3 ) \\ CLD ( k ) = 10 {log}_{10} ( \frac{{e}_{FL} ( k )}{{e}_{SL} ( k )} ) & ( 4 )\end{matrix}$$

The processing for calculating the ICC performed by the R-OTT unit 121a will be described next. The R-OTT unit 121a determines a cross-correlation between the signals FL(k, n) and SL(k, n) and then calculates the ICC based on the determined cross-correlation.

The R-OTT unit 121a determines the cross-correlation eFLSL between the signals FL(k, n) and SL(k, n) using Equation (5). After determining the cross-correlation, the R-OTT unit 121a determines the ICC using Equation (6). Meanwhile, eFL(k) and eSL(k) included in Equation (6) represent autocorrelations determined from Equations (2) and (3), respectively. Additionally, Re{*}represents real part of a complex number *.

$$\begin{matrix}{e}_{FLSL} ( k ) = {\sum }_{n = 0}^{N - 1} FL ( k , n ) \cdot SL ( k , n ) & ( 5 ) \\ ICC ( k ) = Re \{ \frac{{e}_{FLSL} ( k )}{\sqrt{{e}_{FL} ( k ) \cdot {e}_{SL} ( k )}} \} & ( 6 )\end{matrix}$$

Meanwhile, the CLD and the ICC calculated by the R-OTT unit 121a are denoted as CLDL and ICCL, respectively.

The R-OTT unit 121b will be described next. The R-OTT unit 121b generates a downmixed signal and spatial information based on the frequency signals C(k, n) and LFE(k, n). The R-OTT unit 121b outputs the downmixed signal to the R-TTT unit 122. The R-OTT unit 121b also outputs the spatial information to the degree-of-importance converting unit 140 and the spatial information encoding unit 180.

More specifically, the R-OTT unit 121b generates a downmixed signal C′(k, n) by downmixing the signals C(k, n) and LFE(k, n).

The spatial information generated by the R-OTT unit 121b includes a CLD and an ICC. Processing for calculating the CLD and the ICC performed by the R-OTT unit 121b is similar to the processing described above for the R-OTT unit 121a. However, the R-OTT unit 121b calculates the CLD and the ICC based on the signals C(k, n) and LFE(k, n). The CLD and the ICC calculated by the R-OTT unit 121b are denoted as CLDC and ICCC, respectively.

The R-OTT unit 121c will be described next. The R-OTT unit 121c generates a downmixed signal, a residual signal, and spatial information based on the frequency signals FR(k, n) and SR(k, n). The R-OTT unit 121c outputs the downmixed signal to the R-TTT unit 122. The R-OTT unit 121c also outputs the residual signal to the residual encoding unit 170. Additionally, the R-OTT unit 121c outputs the spatial information to the degree-of-importance converting unit 140 and the spatial information encoding unit 180.

More specifically, the R-OTT unit 121c generates a downmixed signal R′(k, n) by downmixing the signals FR(k, n) and SR(k, n). Additionally, the R-OTT unit 121c extracts, as the residual signal, a signal corresponding to a difference between the downmixed signal R′(k, n) and the signals FR(k, n) and SR(k, n). The residual signal extracted by the R-OTT unit 121c is denoted as a residual signal resOTT2(k, n).

The spatial information generated by the R-OTT unit 121c includes a CLD and an ICC. Processing for calculating the CLD and the ICC performed by the R-OTT unit 121c is similar to the processing described above for the R-OTT unit 121a. However, the R-OTT unit 121c calculates the CLD and the ICC based on the signals FR(k, n) and SR(k, n). The CLD and the ICC calculated by the R-OTT unit 121c are denoted as CLDR and ICCR, respectively.

Next, the R-TTT unit 122 illustrated in FIG. 3 will be described. The R-TTT unit 122 is a processing unit that downmixes the downmixed signals L′(k, n), C′(k, n), and R′(k, n) input from the R-OTT units 121a to 121c, respectively. The R-TTT unit 122 also generates a residual signal and spatial information based on the downmixed signals L′(k, n), R′(k, n), and C′(k, n).

The R-TTT unit 122 outputs downmixed signals of the downmixed signals L′(k, n), R′(k, n), and C′(k, n) to the core encoding unit 160. The R-TTT unit 122 also outputs the residual signal to the residual encoding unit 170. Additionally, the R-TTT unit 122 outputs the spatial information to the spatial information encoding unit 180.

More specifically, the R-TTT unit 122 generates two downmixed signals by downmixing the signals L′(k, n), R′(k, n), and C′(k, n). The downmixed signals generated by the R-TTT unit 122 are denoted as downmixed signals L″(k, n) and R″(k, n). The R-TTT unit 122 also extracts, as the residual signal, a difference between the downmixed signals L″(k, n) and R″(k, n) and the downmixed signals L′(k, n), R′(k, n), and C′(k, n). The residual signal generated by the R-TTT unit 122 is denoted as a residual signal resTTT(k, n).

The spatial information generated by the R-TTT unit 122 includes a channel prediction coefficient 1 (CPC1), a CPC2, and an ICC. Processing for calculating the CPC1, the CPC2, and the ICC performed by the R-TTT unit 122 will now be sequentially described.

When calculating the CPC1 or the CPC2, the R-TTT unit 122 first substitutes the downmixed signals L′(k, n), R′(k, n), and C′(k, n) into Equation (7) to calculate the signals L″(k, n), R″(k, n), and C″(k, n).

$$( \begin{matrix}{L}^{″} ( k , n ) \\ {R}^{″} ( k , n ) \\ {C}^{″} ( k , n )\end{matrix} ) = ( \begin{matrix}1 & 0 & \frac{\sqrt{2}}{2} \\ 0 & 1 & \frac{\sqrt{2}}{2} \\ 1 & 1 & - \frac{\sqrt{2}}{2}\end{matrix} ) ( \begin{matrix}{L}^{′} ( k , n ) \\ {R}^{′} ( k , n ) \\ {C}^{′} ( k , n )\end{matrix} ) \qquad ( 7 )$$

The R-TTT unit 122 substitutes the resulting signals L″(k, n) and R″(k, n) into Equation (8) and also substitutes the resulting signal C″(k, n) into Equation (9). The R-TTT unit 122 then determines a combination of CPC1(k) and CPC2(k) that minimizes a value of Error(k) in Equation (9). The combination of the CPC1(k) and the CPC2(k) that minimizes the value of the Error(k) corresponds to the CPC1 and the CPC2 to be determined, respectively.

$$\begin{matrix}{C}_{P}^{″} ( k , n ) = CPC 1 ( k ) \cdot {L}^{″} ( k , n ) + CPC 2 ( k ) \cdot {R}^{″} ( k , n ) & ( 8 ) \\ Error ( k ) = {\sum }_{n = 0}^{N - 1} {( {C}_{P}^{″} ( k , n ) - {C}^{″} ( k , n ) )}^{2} & ( 9 )\end{matrix}$$

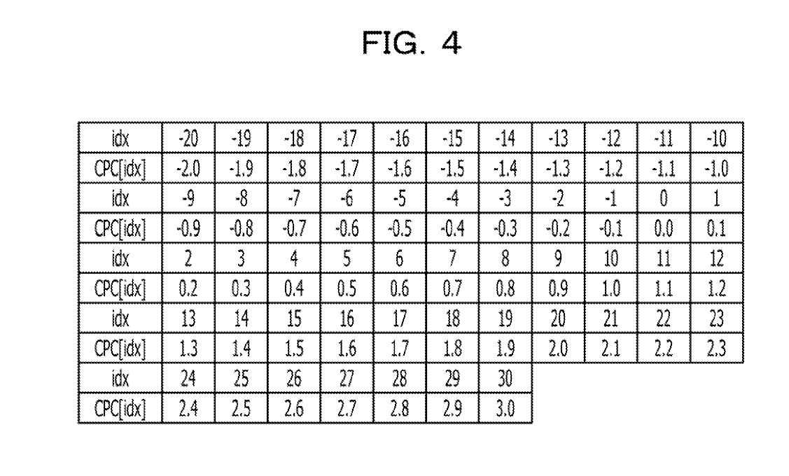

The R-TTT unit 122 may substitute the values of the CPC1(k) and the CPC2(k) into Equation (8) using a quantization table to calculate the combination that minimizes the value of the Error(k). FIG. 4 is a diagram illustrating a data structure of a quantization table. As illustrated in FIG. 4, this quantization table holds an index (idx) and a value of CPC[idx] in association with each other. Here, “idx” represents a value corresponding to “k” in Equation (8).

When the quantization table illustrated in FIG. 4 is used, the R-TTT unit 122 determines the CPC1 and the CPC2 by calculating a combination that minimizes the value of the Error(k) from 51×51 combinations.

As illustrated in a second row of FIG. 4, values of the CPC[idx] are as follows: CPC[−20]=−2.0; CPC[−19]=−1.9; CPC[−18]=−1.8; CPC[−17]=−1.7; CPC[−16]=−1.6; CPC[−15]=−1.5; CPC[−14]=−1.4; CPC[−13]=−1.3; CPC[−12]=−1.2; CPC[−11]=−1.1; and CPC[−10]=−1.0.

As illustrated in a fourth row of FIG. 4, values of the CPC[idx] are as follows: CPC[−9]=−0.9; CPC[−8]=−0.8; CPC[−7]=−0.7; CPC[−6]=−0.6; CPC[−5]=−0.5; CPC[−4]=−0.4; CPC[−3]=−0.3; CPC[−2]=−0.2; CPC[−1]=−0.1; CPC[0]=0.0; and CPC[1]=0.1.

As illustrated in a sixth row of FIG. 4, values of the CPC [idx] are as follows: CPC[2]=0.2; CPC[3]=0.3; CPC[4]=0.4; CPC[5]=0.5; CPC[6]=0.6; CPC[7]=0.7; CPC[8]=0.8; CPC[9]=0.9; CPC[10]=1.0; CPC[11]=1.1; and CPC[12]=1.2.

As illustrated in an eighth row of FIG. 4, values of the CPC[idx] are as follows: CPC[13]=1.3; CPC[14]=1.4; CPC[15]=1.5; CPC[16]=1.6; CPC[17]=1.7; CPC[18]=1.8; CPC[19]=1.9; CPC[20]=2.0; CPC[21]=2.1; CPC[22]=2.2; and CPC[23]=2.3.

As illustrated in a tenth row of FIG. 4, values of the CPC[idx] are as follows: CPC[24]=2.4; CPC[25]=2.5; CPC[26]=2.6; CPC[27]=2.7; CPC[28]=2.8, CPC[29]=2.9; and CPC[30]=3.0.

The processing for calculating the ICC performed by the R-TTT unit 122 will now be described. For example, the R-TTT unit 122 calculates the ICC based on Equation (10).

$$ICC ( k ) = \frac{{e}_{l} ( k ) + {e}_{r} ( k ) + {e}_{c} ( k )}{{e}_{{L}^{′}} ( k ) + {e}_{{R}^{′}} ( k ) + {e}_{{C}^{′}} ( k )} \qquad ( 10 )$$

In Equation (10), eL′(k) represents an autocorrelation of the downmixed signal L′(k, n). The R-TTT unit 122 calculates the autocorrelation eL′(k) using Equation (11).

$${e}_{{L}^{′}} ( k ) = {\sum }_{n = 0}^{N - 1} {\vert {L}^{′} ( k , n ) \vert}^{2} \qquad ( 11 )$$

In Equation (10), eR′(k) represents an autocorrelation of the downmixed signal R′(k, n). The R-TTT unit 122 calculates the autocorrelation eR′(k) using Equation (12).

$${e}_{{R}^{′}} ( k ) = {\sum }_{n = 0}^{N - 1} {\vert {R}^{′} ( k , n ) \vert}^{2} \qquad ( 12 )$$

In Equation (10), eC′(k) represents an autocorrelation of the downmixed signal C′(k, n). The R-TTT unit 122 calculates the autocorrelation eC′(k) using Equation (13).

$${e}_{{C}^{′}} ( k ) = {\sum }_{n = 0}^{N - 1} {\vert {C}^{′} ( k , n ) \vert}^{2} \qquad ( 13 )$$

In Equation (10), el(k) represents an autocorrelation of a signal l(k, n). The R-TTT unit 122 calculates the autocorrelation el(k) using Equation (14). In Equation (14), the signal l(k, n) represents an estimated decoded signal of an L′ channel. The R-TTT unit 122 calculates the signal l(k, n) using Equation (15).

$$\begin{matrix} {e}_{l} ( k ) = {\sum }_{n = 0}^{N - 1} {\vert l ( k , n ) \vert}^{2} & ( 14 ) \\ l ( k , n ) = \frac{1}{3} \{ ( CPC 1 ( k ) + 2 ) \cdot {L}^{″} ( k , n ) + ( CPC 2 ( k ) - 1 ) \cdot {R}^{″} ( k , n ) \} & ( 15 )\end{matrix}$$

In Equation (10), er(k) represents an autocorrelation of a signal r(k, n). The R-TTT unit 122 calculates the autocorrelation er(k) using Equation (16). In Equation (16), the signal r(k, n) represents an estimated decoded signal of an R′ channel. The R-TTT unit 122 calculates the signal r(k, n) using Equation (17).

$$\begin{matrix} {e}_{r} ( k ) = {\sum }_{n = 0}^{N - 1} {\vert r ( k , n ) \vert}^{2} & ( 16 ) \\ r ( k , n ) = \frac{1}{3} \{ ( CPC 1 ( k ) - 1 ) \cdot {L}^{″} ( k , n ) + ( CPC 2 ( k ) + 2 ) \cdot {R}^{″} ( k , n ) \} & ( 17 )\end{matrix}$$

In Equation (10), ec(k) represents an autocorrelation of a signal c(k, n). The R-TTT unit 122 calculates the signal ec(k) using Equation (18). In Equation (18), the signal c(k, n) represents an estimated decoded signal of a C′ channel. The R-TTT unit 122 calculates the signal c(k, n) using Equation (19).

$$\begin{matrix} {e}_{c} ( k ) = {\sum }_{n = 0}^{N - 1} {\vert c ( k , n ) \vert}^{2} & ( 18 ) \\ c ( k , n ) = \frac{1}{3} \{ ( 1 - CPC 1 ( k ) ) \sqrt{2} \cdot {L}^{″} ( k , n ) + ( 1 - CPC 2 ( k ) ) \sqrt{2} \cdot {R}^{″} ( k , n ) \} & ( 19 )\end{matrix}$$

That is, the R-TTT unit 122 calculates the autocorrelations eL′(k), eR′(k), eC′(k), el(k), er(k), and ec(k) based on Equations (11) to (19). The R-TTT unit 122 then calculates the ICC based on Equation (10).

Referring back to FIG. 1, the degree-of-importance calculating unit 130 is a processing unit that calculates a degree of importance of each signal included in the frequency signals. As described above, the frequency signals include the FL(k, n), the SL(k, n), the FR(k, n), the SR(k, n), the C(k, n), and the LFE(k, n). In a description below, degrees of importance of the frequency signals FL(k, n), SL(k, n), FR(k, n), SR(k, n), C(k, n), and LFE(k, n) are denoted as P(FL), P(SL), P(FR), P(SR), P(C), and P(LFE), respectively. The degree-of-importance calculating unit 130 outputs each of the calculated degrees of importance to the degree-of-importance converting unit 140.

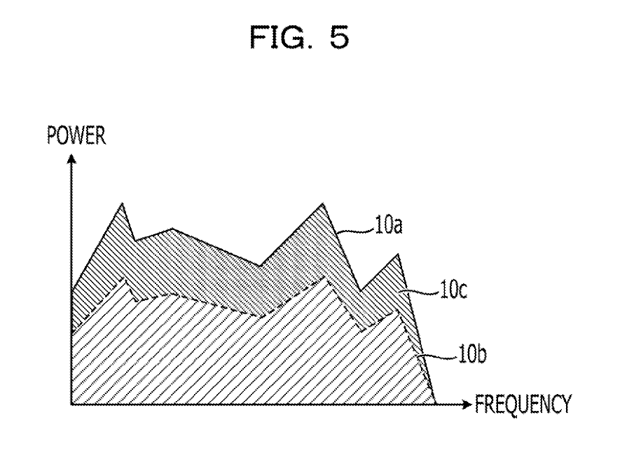

An overview about the degrees of importance calculated by the degree-of-importance calculating unit 130 will be described first. The degree-of-importance calculating unit 130 calculates, as the degree of importance, perceptual entoropy. FIG. 5 is a diagram for describing the processing of the degree-of-importance calculating unit 130. A horizontal axis of FIG. 5 represents frequency, whereas a vertical axis thereof represents power of frequency signals. A reference 10a illustrated in FIG. 5 represents a waveform of one of the signals included in the frequency signals, whereas a reference 10b represents a waveform of masking power. The masking power indicates an allowable range of errors caused by quantization. Accordingly, signal errors existing in an area equal to or below the masking power 10b are ignorable. In contrast, signal errors in an area above the masking power 10b are not ignorable and the degree of importance increases in proportion to the size of this area. The degree-of-importance calculating unit 130 calculates, as the degree of importance of the signal 10a, an area 10c between the signal 10a and the masking power 10b. For example, when the signal FL(k, n) serves as the signal 10a, the size of the area 10c corresponds to the degree of importance P(FL).

A description will now be given for processing for calculating the degree of importance performed by the degree-of-importance calculating unit 130. Here, an example case will be described in which the degree-of-importance calculating unit 130 calculates the degree of importance P(FL) of the frequency signal FL(k, n). The degree-of-importance calculating unit 130 calculates the degree of importance P(FL) using Equation (20).

$$P ( FL ) = - {\sum }_{n = 0}^{127} {\sum }_{k = 0}^{63} log 10 ( nb ( FL , n , k ) / e ( FL , n , k ) ) \qquad ( 20 )$$

In Equation (20), nb(FL, n, k) corresponds to masking power for an FL channel. Additionally, e(FL, n, k) is spectral power determined with Equation (21). Meanwhile, it is assumed that the degree-of-importance calculating unit 130 stores information about masking power.

e(FL,n,k)=FL(k,n)² (21)

As the masking power, power of a minimum audible field of each frequency band may be used. Alternatively, the degree-of-importance calculating unit 130 may use a method recited in “New Implementation Techniques of an Efficient MPEG Advanced Audio Coder” written by E. Kurniawati, C. T. Lau, B. Premkumar, J. Absar, and S. George. (IEEE Transactions on Consumer Electronics, vol. 50 no. 2 P. 655-665, 2004)

Similarly to the frequency signal FL(k, n), the degree-of-importance calculating unit 130 also calculates the degrees of importance of the frequency signals SL(k, n), FR(k, n), SR(k, n), C(k, n), and LFE(k, n). The degree-of-importance calculating unit 130 outputs the calculated degrees of importance P(FL), P(SL), P(FR), P(SR), P(C), and P(LFE) to the degree-of-importance converting unit 140.

Processing performed by the degree-of-importance converting unit 140 will be described next. The degree-of-importance converting unit 140 is a processing unit that downmixes a plurality of degrees of importance. The degree-of-importance converting unit 140 downmixes the degrees of importance for 6 channels into those for 5 channels. The number of channels of signals output from the degree-of-importance converting unit 140 is equal to the number of channels of signals output from the signal converting unit 120.

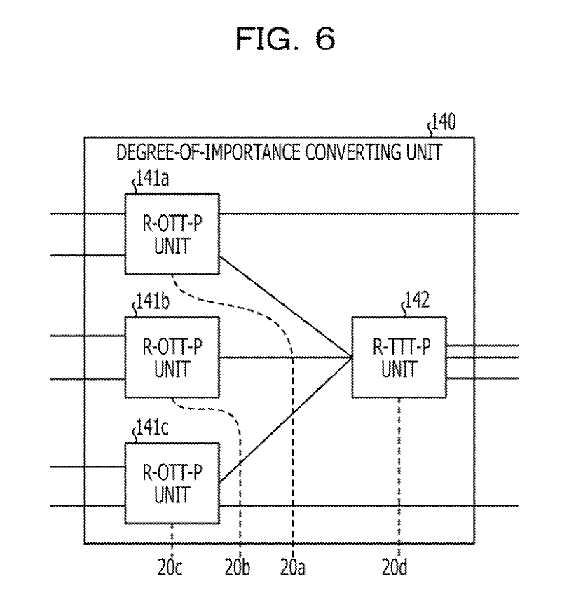

An example of a configuration of the degree-of-importance converting unit 140 will be described. FIG. 6 is a diagram illustrating a configuration of the degree-of-importance converting unit 140. As illustrated in FIG. 6, the degree-of-importance converting unit 140 includes R-OTT-P units 141a to 141c and an R-TTT-P unit 142.

The R-OTT-P unit 141a will be described. The R-OTT-P unit 141a acquires the degrees of importance P(FL) and P(SL) and spatial information 20a and generates a degree of importance P(L′) of the downmixed signal and a degree of importance P(resOTT1) of the residual signal. Meanwhile, the spatial information 20a corresponds to the spatial information generated by the R-OTT unit 121a illustrated in FIG. 3. The R-OTT-P unit 141a outputs the degree of importance P(L′) of the downmixed signal to the R-TTT-P unit 142. The R-OTT-P unit 141a outputs the degree of importance P(resOTT1) of the residual signal to the number-of-bits determining unit 150.

The R-OTT-P unit 141b will be described. The R-OTT-P unit 141b acquires the degrees of importance P(C) and P(LFE) and spatial information 20b and generates a degree of importance P(C′) of the downmixed signal. Meanwhile, the spatial information 20b corresponds to the spatial information generated by the R-OTT unit 121b. The R-OTT-P unit 141b outputs the degree of importance P(C′) of the downmixed signal to the R-TTT-P unit 142.

The R-OTT-P unit 141c will be described. The R-OTT-P unit 141c acquires the degrees of importance P(FR) and P(SR) and spatial information 20c and generates a degree of importance P(R′) of the downmixed signal and a degree of importance P(resOTT2) of the residual signal. Meanwhile, the spatial information 20c corresponds to spatial information generated by the R-OTT unit 121c. The R-OTT-P unit 141c outputs the degree of importance P(R′) of the downmixed signal to the R-TTT-P unit 142. The R-OTT-P unit 141c outputs the degree of importance P(resOTT2) of the residual signal to the number-of-bits determining unit 150.

The R-TTT-P unit 142 will be described. The R-TTT-P unit 142 acquires the degrees of importance P(L′), P(C′), and P(R′) of the downmixed signals and spatial information 20d and generates degrees of importance P(L″) and P(R″) of the downmixed signals. The R-TTT-P unit 142 also generates a degree of importance P(resTTT) of the residual signal based on the degrees of importance P(L′), P(C′), and P(R′) of the downmixed signals and the spatial information 20d. Meanwhile, the spatial information 20d corresponds to the spatial information generated by the R-TTT unit 122 illustrated in FIG. 3. The R-TTT-P unit 142 outputs the degrees of importance P(L″) and P(R″) of the downmixed signals and the degree of importance P(resTTT) of the residual signal to the number-of-bits determining unit 150.

In this manner, the degree-of-importance converting unit 140 converts the degrees of importance P(FL), P(SL), P(FR), P(SR), P(C), and P(LFE) into the degrees of importance P(L″) and P(R″) of the downmixed signals and the degrees of importance P(resOTT1), P(resOTT2), and P(resTTT) of the residual signals.

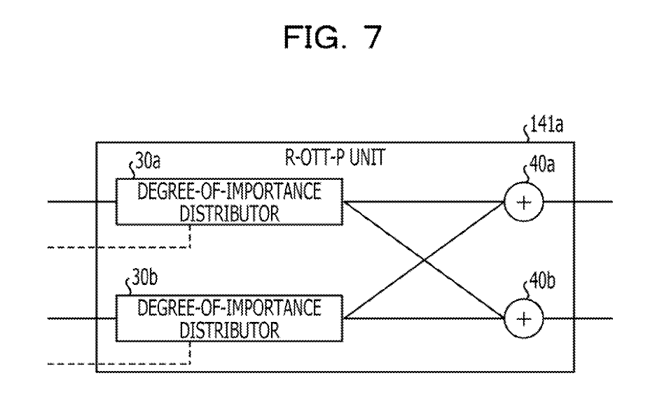

A configuration of the R-OTT-P unit 141a illustrated in FIG. 6 will now be described. FIG. 7 is a diagram illustrating a configuration of the R-OTT-P unit 141a. As illustrated in FIG. 7, the R-OTT-P unit 141a includes degree-of-importance distributors 30a and 30b and adders 40a and 40b.

The degree-of-importance distributor 30a is a processing unit that receives the degree of importance P(FL) and the spatial information 20a and executes two kinds of calculation. More specifically, the degree-of-importance distributor 30a executes calculations represented by Equations (22) and (23). “H1” included in Equations (22) and (23) corresponds to the spatial information. For example, a value of H1 is determined from the CLDL and the ICCL using Equations (39) to (43).

$$\begin{matrix}\frac{1}{1 + \vert H 1 \vert} \cdot P ( FL ) & ( 22 ) \\ \frac{\vert H 1 \vert}{1 + \vert H 1 \vert} \cdot P ( FL ) & ( 23 ) \\ H 1 = k 1 \times cos ( α + β ) & ( 39 ) \\ k 1 = \sqrt{\frac{{10}^{\frac{{CLD}_{L}}{10}}}{1 + {10}^{\frac{{CLD}_{L}}{10}}}} & ( 40 ) \\ k 2 = \sqrt{\frac{1}{1 + {10}^{\frac{{CLD}_{L}}{10}}}} & ( 41 ) \\ β = arctan \{ tan ( α ) \frac{k 2 - k 1}{k 2 + k 1} \} & ( 42 ) \\ α = \frac{1}{2} arccos ( {ICC}_{L} ) & ( 43 ) \\ H 2 = k 2 \times cos ( - α + β ) & ( 44 )\end{matrix}$$

The degree-of-importance distributor 30a outputs the calculation result obtained with Equation (22) to the adder 40a. The degree-of-importance distributor 30a also outputs the calculation result obtained with Equation (23) to the adder 40b.

The degree-of-importance distributor 30b is a processing unit that receives the degree of importance P(SL) and the spatial information and executes two kinds of calculation. More specifically, the degree-of-importance distributor 30b executes calculations represented by Equations (24) and (25). “H2” included in Equations (24) and (25) corresponds to the spatial information. For example, a value of the H2 is determined from the CLDL and the ICCL using Equations (44) and (40) to (43).

$$\begin{matrix}\frac{1}{1 + \vert H 2 \vert} \cdot P ( SL ) & ( 24 ) \\ \frac{\vert H 2 \vert}{1 + \vert H 2 \vert} \cdot P ( SL ) & ( 25 )\end{matrix}$$

The degree-of-importance distributor 30b outputs the calculation result obtained with Equation (24) to the adder 40a. The degree-of-importance distributor 30b outputs the calculation result obtained with Equation (25) to the adder 40b.

The adder 40a is a processing unit that adds the calculation results output from the degree-of-importance distributors 30a and 30b. A result P(M) of addition performed by the adder 40a can be represented by Equation (26).

$$P ( M ) = \frac{1}{1 + \vert H 1 \vert} \cdot P ( FL ) + \frac{1}{1 + \vert H 2 \vert} \cdot P ( SL ) \qquad ( 26 )$$

The value P(M) calculated with Equation (26) corresponds to the degree of importance P(L′) of the downmixed signal. The adder 40a outputs the addition result P(M) to the R-TTT-P unit 142.

The adder 40b is a processing unit that adds the calculation results output from the degree-of-importance distributors 30a and 30b. A result P(resOTT) of addition performed by the adder 40b can be represented by Equation (27).

$$P ( resOTT ) = \frac{\vert H 1 \vert}{1 + \vert H 1 \vert} \cdot P ( FL ) + \frac{\vert H 2 \vert}{1 + \vert H 2 \vert} \cdot P ( SL ) \qquad ( 27 )$$

The value P(resOTT) calculated with Equation (27) corresponds the degree-of-importance P(resOTT1) of the residual signal. The adder 40b outputs the addition result P(resOTT) to the number-of-bits determining unit 150.

A configuration of the R-OTT-P unit 141b will be described. The configuration of the R-OTT-P unit 141b is similar to that of the R-OTT-P unit 141a. However, the R-OTT-P unit 141b calculates a value P(M) based on the degree of importance P(C), the degree of importance P(LFE), and the spatial information 20b. The value P(M) corresponds to the degree of importance P(C′) of the downmixed signal. The R-OTT-P unit 141b outputs the value P(M) to the R-TTT-P unit 142.

A configuration of the R-OTT-P unit 141c will be described. The configuration of the R-OTT-P unit 141c is similar to that of the R-OTT-P unit 141a. However, the R-OTT-P unit 141c calculates values P(M) and P(resOTT) based on the degree of importance P(FR), the degree of importance P(SR), and the spatial information 20c. The value P(M) corresponds to the degree of importance P(R′) of the downmixed signal, whereas the value P(resOTT) corresponds to the degree of importance P(resOTT2) of the residual signal. The R-OTT-P unit 141c outputs the value P(M) to the R-TTT-P unit 142. The R-OTT-P unit 141c also outputs the value P(resOTT) to the number-of-bits determining unit 150.

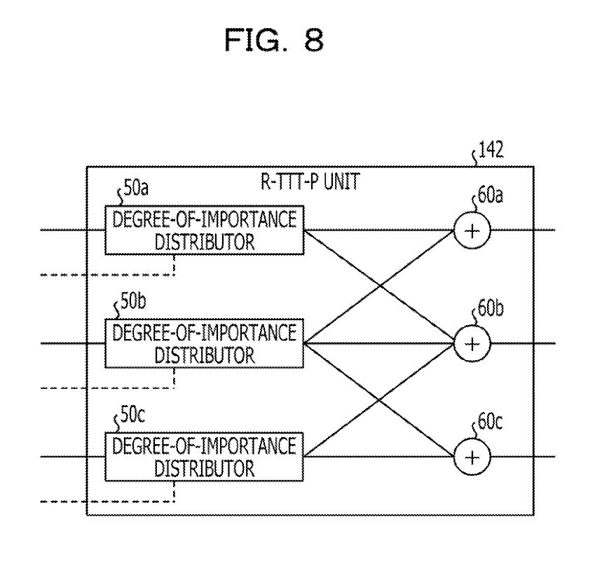

A configuration of the R-TTT-P unit 142 illustrated in FIG. 6 will be described next. FIG. 8 is a diagram illustrating a configuration of the R-TTT-P unit 142. As illustrated in FIG. 8, the R-TTT-P unit 142 includes degree-of-importance distributors 50a, 50b, and 50c and adders 60a, 60b, and 60c.

The degree-of-importance distributor 50a is a processing unit that receives the degree of importance P(L′) of the downmixed signal and the spatial information 20d and executes two kinds of calculation. More specifically, the degree-of-importance distributor 50a executes calculations represented by Equations (28) and (29) to determine values P(L1) and P(L2). “c1” included in Equations (28) and (29) corresponds to the spatial information 20d. For example, “c1” corresponds to the CPC1, whereas “c2” corresponds to the CPC2.

$$\begin{matrix}P ( L 1 ) = \frac{1}{1 + \vert ( 1 - c 1 ) \vert} \cdot P ( {L}^{′} ) & ( 28 ) \\ P ( L 2 ) = \frac{\vert ( 1 - c 1 ) \vert}{1 + \vert ( 1 - c 1 ) \vert} \cdot P ( {L}^{′} ) & ( 29 )\end{matrix}$$

The degree-of-importance distributor 50a outputs the value P(L1) to the adder 60a. The degree-of-importance distributor 50a also outputs the value P(L2) to the adder 60b.

The degree-of-importance distributor 50b is a processing unit that receives the degree of importance P(C′) of the downmixed signal and the spatial information 20d and executes three kinds of calculation. More specifically, the degree-of-importance distributor 50b executes calculations represented by Equations (30), (31), and (32) to determine values P(C1), P(C2), and P(C3). “c1” and “c2” included in Equations (30), (31), and (32) correspond to the spatial information.

$$\begin{matrix}P ( C 1 ) = \frac{1}{1 + \vert ( 1 + c 1 + c 2 ) \vert} \cdot P ( {C}^{′} ) & ( 30 ) \\ P ( C 2 ) = \frac{\vert ( 1 + c 1 + c 2 ) \vert}{1 + \vert ( 1 + c 1 + c 2 ) \vert} \cdot P ( {C}^{′} ) & ( 31 ) \\ P ( C 3 ) = \frac{1}{1 + \vert ( 1 + c 1 + c 2 ) \vert} \cdot P ( {C}^{′} ) & ( 32 )\end{matrix}$$

The degree-of-importance distributor 50b outputs the value P(C1) to the adder 60a. The degree-of-importance distributor 50b also outputs the value P(C2) to the adder 60b. Additionally, the degree-of-importance distributor 50b outputs the value P(C3) to the adder 60c.

The degree-of-importance distributor 50c is a processing unit that receives the degree of importance P(R′) of the downmixed signal and the spatial information and executes two kinds of calculation. More specifically, the degree-of-importance distributor 50c executes calculations represented by Equations (33) and (34) to determine values P(R1) and P(R2), respectively. “c2” included in Equations (33) and (34) corresponds to the spatial information. The degree-of-importance distributor 50c outputs the value P(R1) to the adder 60b and also outputs the value P(R2) to the adder 60c.

$$\begin{matrix}P ( R 1 ) = \frac{\vert ( 1 - c 2 ) \vert}{1 + \vert ( 1 - c 2 ) \vert} \cdot P ( {R}^{′} ) & ( 33 ) \\ P ( R 2 ) = \frac{1}{1 + \vert ( 1 - c 2 ) \vert} \cdot P ( {R}^{′} ) & ( 34 )\end{matrix}$$

The adder 60a is a processing unit that adds the value P(L1) to the value P(C1). A result P(L″) of addition performed by the adder 60a can be represented by Equation (35).

$$P ( {L}^{″} ) = \frac{1}{1 + \vert ( 1 - c 1 ) \vert} \cdot P ( {L}^{′} ) + \frac{1}{1 + \vert ( 1 + c 1 + c 2 ) \vert} \cdot P ( {C}^{′} ) \qquad ( 35 )$$

The addition result P(L″) calculated with Equation (35) is for the aforementioned downmixed signal L″(k, n). The adder 60a outputs the addition result P(L″) to the number-of-bits determining unit 150.

The adder 60b is a processing unit that adds the values P(L2), P(C2), and P(R1). A result P(resTTT) of addition performed by the adder 60b can be represented by Equation (36).

$$P ( resTTT ) = \frac{\vert ( 1 - c 1 ) \vert}{1 + \vert ( 1 - c 1 ) \vert} \cdot P ( {L}^{′} ) + \frac{\vert ( 1 - c 2 ) \vert}{1 + \vert ( 1 - c 2 ) \vert} \cdot P ( {R}^{′} ) + \frac{\vert ( 1 + c 1 + c 2 ) \vert}{1 + \vert ( 1 + c 1 + c 2 ) \vert} \cdot P ( {C}^{′} ) \qquad ( 36 )$$

The value P(resTTT) calculated with Equation (36) is for the aforementioned residual signal resTTT(k, n). The adder 60b outputs the addition result P(resTTT) to the number-of-bits determining unit 150.

The adder 60c is a processing unit that adds the values P(C3) and P(R2). A result P(R″) of addition performed by the adder 60c can be represented by Equation (37).

$$P ( {R}^{″} ) = \frac{1}{1 + \vert ( 1 - c 2 ) \vert} \cdot P ( {R}^{′} ) + \frac{1}{1 + \vert ( 1 + c 1 + c 2 ) \vert} \cdot P ( {C}^{′} ) \qquad ( 37 )$$

The value P(R″) calculated with Equation (37) is for the aforementioned downmixed signal R″(k, n). The adder 60c outputs the addition result P(R″) to the number-of-bits determining unit 150.

Referring back to FIG. 1, the number-of-bits determining unit 150 is a processing unit that calculates bit allocation of the core encoding unit 160 and the residual encoding unit 170 based on the 5-channel signals acquired from the degree-of-importance converting unit 140. The 5-channel signals acquired by the number-of-bits determining unit 150 from the degree-of-importance converting unit 140 include the signals P(L″), P(R″), P(resTTT), P(resOTT1), and P(resOTT2).

The number-of-bits determining unit 150 calculates bit allocation for quantizing the downmixed signal L″(k, n) based on the signal P(L″). The number-of-bits determining unit 150 also calculates bit allocation for quantizing the downmixed signal R″(k, n) based on the signal P(R″).

The number-of-bits determining unit 150 calculates bit allocation for quantizing the residual signal resOTT1(k, n) based on the signal P(resOTT1). The number-of-bits determining unit 150 also calculates bit allocation for quantizing the residual signal resOTT2(k, n) based on the signal P(resOTT2). The number-of-bits determining unit 150 calculates bit allocation for quantizing the residual signal resTTT(k, n) based on the signal P(resTTT).

More specifically, the processing for calculating the bit allocation performed by the number-of-bits determining unit 150 will be described. A description will be given for the signal P(L″) here, for example. The number-of-bits determining unit 150 calculates a degree of importance Ps(L″, n) by adding all degrees of importance for frequencies included in the signal P(L″). For example, the number-of-bits determining unit 150 calculates the degree of importance Ps(L″, n) using Equation (38). Meanwhile, P(L″, k, n) on a right side of Equation (38) corresponds to the signal P(L″).

$$Ps ( {L}^{″} , n ) = {\sum }_{k} P ( {L}^{″} , k , n ) \qquad ( 38 )$$

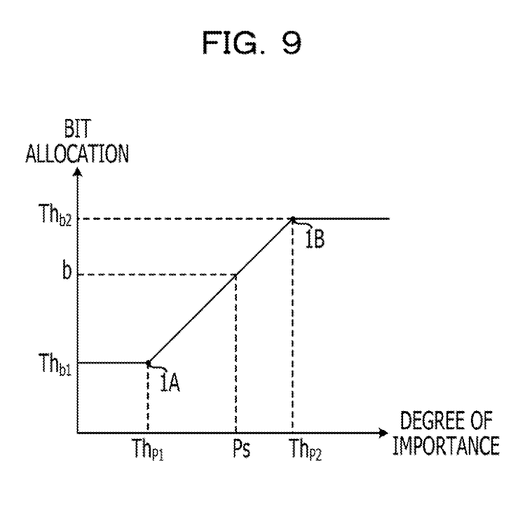

For example, the number-of-bits determining unit 150 compares a graph illustrating a relation between bit allocation and a degree of importance with the value Ps(L″, n) to determine the bit allocation. FIG. 9 is a diagram illustrating the relation between the bit allocation and the degree of importance. A horizontal axis of FIG. 9 represents a degree of importance, whereas a vertical axis thereof represents bit allocation. Values of ThP1 and ThP2 on the horizontal axis are equal to, for example, 4000 and 7000, respectively. Values of Thb1 and Thb2 on the vertical axis are equal to, for example, 500 and 5000, respectively.

The number-of-bits determining unit 150 compares a line connecting a point 1A to a point 1B with the value Ps(L″, n) to determine bit allocation for the value Ps(L″, n). In the example illustrated in FIG. 9, the bit allocation for the value Ps(L″, n) is “b”.

The number-of-bits determining unit 150 calculates bit allocation for the signals P(R″), P(resTTT), P(resOTT1), and P(resOTT2) in a manner similar to that for the signal P(L″). The number-of-bits determining unit 150 outputs the bit allocation determined from the signal P(L″) and the bit allocation determined from the signal P(R″) to the core encoding unit 160. The number-of-bits determining unit 150 also outputs the bit allocation determined from each of the signals P(resTTT), P(resOTT1), and P(resOTT2) to the residual encoding unit 170.

Referring back to FIG. 1, the core encoding unit 160 quantizes the downmixed signal L″(k, n) so that the quantized signal fits into the bit allocation for the signal P(L″) calculated by the number-of-bits determining unit 150. The core encoding unit 160 also quantizes the downmixed signal R″(k, n) so that the quantized signal fits into the bit allocation for the signal P(R″) calculated by the number-of-bits determining unit 150.

When the core encoding unit 160 quantizes the downmixed signals L″(k, n) and R″(k, n), a given coding scheme is used. For example, the core encoding unit 160 quantizes the downmixed signals L″(k, n) and R″(k, n) using advanced audio coding (AAC) and spectral band replication (SBR). The core coding unit 160 quantizes low-frequency components of the downmixed signals L″(k, n) and R″(k, n) using the AAC and quantizes high-frequency components thereof using the SBR. When performing the AAC coding, the core encoding unit 160 uses, for example, a technique disclosed in Japanese Laid-open Patent Publication No. 2007-183528. When performing the SBR coding, the core encoding unit 160 uses, for example, a technique disclosed in Japanese Laid-open Patent Publication No. 2008-224902.

The core encoding unit 160 is a processing unit that quantizes the downmixed signals L″(k, n) and R″(k, n) output from the R-TTT unit 122 illustrated in FIG. 3. The core encoding unit 160 performs the AAC coding and the SBR coding on the downmixed signal L″(k, n) so that the quantized signal fits into the bit allocation for the signal P(L″). Additionally, the core encoding unit 160 performs the AAC coding and the SBR coding on the downmixed signal R″(k, n) so that the quantized signal fits into the bit allocation for the signal P(R″). The core encoding unit 160 outputs the quantized downmixed signals L″(k, n) and R″(k, n) to the multiplexing unit 190.

The residual coding unit 170 is a processing unit that quantizes the residual signals resTTT(k, n), resOTT1(k, n), and resOTT2(k, n) output from the R-TTT unit 122, the R-OTT unit 121a, and the R-OTT unit 121c, respectively. The residual encoding unit 170 quantizes the residual signal resTTT(k, n) so that the quantized signal fits into the bit allocation for the signal P(resTTT). Additionally, the residual encoding unit 170 quantizes the residual signal resOTT1(k, n) so the quantized signal fits into the bit allocation for the signal P(resOTT1). The residual encoding unit 170 also quantizes the residual signal resOTT2(k, n) so that the quantized signal fits into the bit allocation for the signal P(resOTT2).

When quantizing the residual signals resTTT(k, n), resOTT1(k, n), and resOTT2(k, n), the residual encoding unit 170 uses a given coding scheme. For example, the residual encoding unit 170 quantizes the residual signals resTTT(k, n), resOTT1(k, n), and resOTT2(k, n) using the AAC coding. The residual encoding unit 170 outputs the quantized residual signals resTTT(k, n), resOTT1(k, n), and resOTT2(k, n) to the multiplexing unit 190.

The spatial information encoding unit 180 is a processing unit that quantizes the spatial information output from the R-OTT units 121a to 121c and the R-TTT unit 122. As described above, the spatial information includes the CLD, the ICC, and the CPC. Quantization performed on the CLD, the ICC, and the CPC by the spatial information encoding unit 180 will be described below.

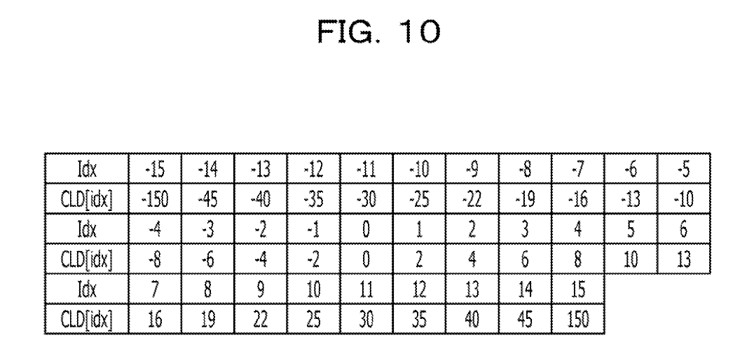

Processing for quantizing the CLD performed by the spatial information encoding unit 180 will be described. The spatial information encoding unit 180 compares a CLD quantization table with a value of the CLD to quantize the CLD. FIG. 10 is a diagram illustrating a data structure of the CLD quantization table. As illustrated in FIG. 10, this CLD quantization table holds an index (idx) and a value of CPC[idx] in association with each other.

As illustrated on a second row of FIG. 10, values of CLD[idx] are as follows: CLD[−15]=−150; CLD[−14]=−45; CLD[−13]=−40; CLD[−12]=−35; CLD[−11]=−30; CLD[−10]=−25; CLD[−9]=−22; and CLD[−8]=−19; CLD[−7]=−16; CLD[−6]=−13; and CLD[−5]=−10.

As illustrated on a fourth row of FIG. 10, values of CLD[idx] are as follows: CLD[−4]=−8; CLD[−3]=−6; CLD[−2]=−4; CLD[−1]=−2; CLD[0]=0; CLD[1]=2; CLD[2]=4; CLD[3]=6; CLD[4]=8; CLD[5]=10; and CLD[6]=13.

As illustrated on a sixth row of FIG. 10, values of CLD[idx] are as follows: CLD[7]=16; CLD[8]=19; CLD[9]=22; CLD[10]=25; CLD[11]=30; CLD[12]=35; CLD[13]=40; CLD[14]=45; and CLD[15]=150.

The spatial information encoding unit 180 detects a CLD[idx] value that is the closest to the CLD value from the CLD[idx] values of the CLD quantization table. The spatial information encoding unit 180 then uses the value of “idx” for the detected CLD[idx] as the quantized CLD value. For example, when the CLD value is equal to “10.8 dB”, the CLD[idx] value closest to this value is the value of the CLD[5], i.e., 10. Accordingly, the spatial information encoding unit 180 quantizes the CLD value “10.8 dB” into the value “5”.

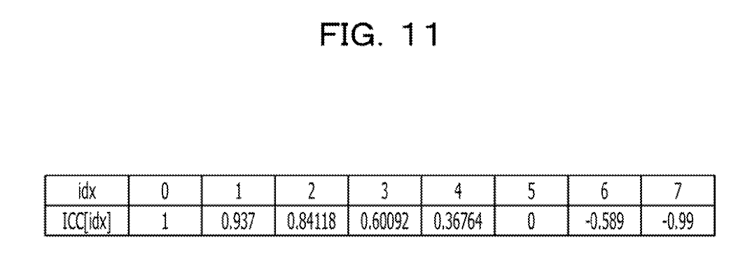

Processing for quantizing the ICC performed by the spatial information encoding unit 180 will be described next. The spatial information encoding unit 180 compares an ICC quantization table with the ICC value to quantizes the ICC. FIG. 11 is a diagram illustrating a data structure of the ICC quantization table. As illustrated in FIG. 11, the ICC quantization table holds an index (idx) and a value of ICC[idx] in association with each other.

As illustrated in FIG. 11, values of ICC[idx] are as follows: ICC[0]=1; ICC[1]=0.937; ICC[2]=0.84118; ICC[3]=0.60092; ICC[4]=0.36764; ICC[5]=0; ICC[6]=−0.589; and ICC[7]=−0.99.

The spatial information encoding unit 180 detects an ICC[idx] value that is the closest to the ICC value from the ICC[idx] values of the ICC quantization table. The spatial information encoding unit 180 then uses a value of “idx” for the detected ICC[idx] value as the quantized ICC value. For example, when the ICC value is equal to “0.6”, the ICC [idx] value closest to this value is the value of the ICC[3], i.e., 0.60092. Accordingly, the spatial information encoding unit 180 quantizes the ICC value “0.6” into the value “3”.

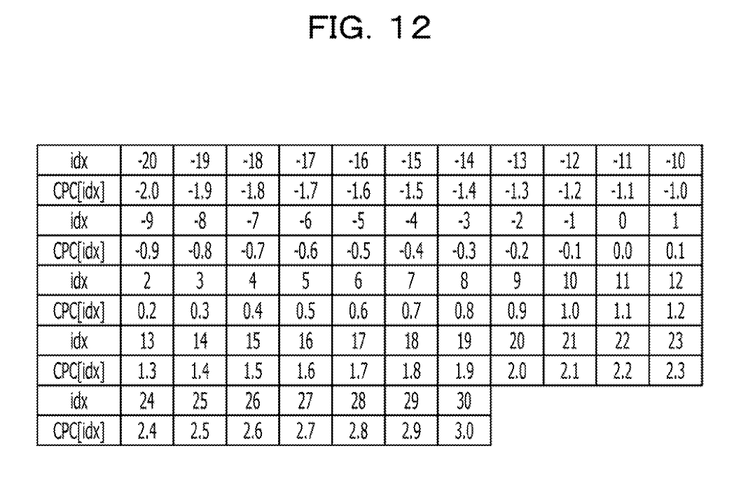

Processing for quantizing the CPC performed by the spatial information encoding unit 180 will be described next. The CPC to be quantized by the spatial information encoding unit 180 includes the CPC1 and the CPC2. The spatial information encoding unit 180 compares a CPC quantization table with the CPC value to quantize the CPC. FIG. 12 is a diagram illustrating a data structure of the CPC quantization table. As illustrated in FIG. 12, the CPC quantization table holds an index (idx) and a value of CPC[idx] in association with each other.

As illustrated on a second row of FIG. 12, values of CPC[idx] are as follows: CPC[−20]=−2.0; CPC[−19]=−1.9; CPC[−18]=−1.8; CPC[−17]=−1.7; CPC[−16]=−1.6; CPC[−15]=−1.5; CPC[−14]=−1.4; CPC[−13]=−1.3; CPC[−12]=−1.2; CPC[−11]=−1.1; and CPC[−10]=−1.0.

As illustrated on a fourth row of FIG. 12, values of CPC[idx] are as follows: CPC[−9]=−0.9; CPC[−8]=−0.8; CPC[−7]=−0.7; CPC[−6]=−0.6; CPC[−5]=−0.5; CPC[−4]=−0.4; CPC[−3]=−0.3; CPC[−2]=−0.2; CPC[−1]=−0.1; CPC[0]=0; and CPC[1]=0.1.

As illustrated on a sixth row of FIG. 12, values of CPC[idx] are as follows: CPC[2]=0.2; CPC[3]=0.3; CPC[4]=0.4; CPC[5]=0.5; CPC[6]=0.6; CPC[7]=0.7; CPC[8]=0.8; CPC[9]=0.9; CPC[10]=1.0; CPC[11]=1.1; and CPC[12]=1.2.

As illustrated in an eighth row of FIG. 12, values of CPC[idx] are as follows: CPC[13]=1.3; CPC[14]=1.4; CPC[15]=1.5; CPC[16]=1.6; CPC[17]=1.7; CPC[18]=1.8; CPC[19]=1.9; CPC[20]=2.0; CPC[21]=2.1; CPC[22]=2.2; and CPC[23]=2.3.

As illustrated in a tenth row of FIG. 12, values of CPC[idx] are as follows: CPC[24]=2.4; CPC[25]=2.5; CPC[26]=2.6; CPC[27]=2.7; CPC[28]=2.8; CPC[29]=2.9; and CPC[30]=3.0.

The spatial information encoding unit 180 detects a CPC[idx] value that is the closest to the CPC value from the CPC[idx] values of the CPC quantization table. The spatial information encoding unit 180 uses a value of “idx” for the detected CPC[idx] value as the quantized CPC value. For example, when the CPC value is equal to “1.21”, the CPC[idx] value closest to this value is the value of CPC[12], i.e., 1.2. Accordingly, the spatial information encoding unit 180 quantizes the CPC value “1.21” into the value “12”.

The spatial information encoding unit 180 outputs the encoded spatial information to the multiplexing unit 190.

Referring back to FIG. 1, the multiplexing unit 190 is a processing unit that acquires the pieces of encoded data from the core encoding unit 160, the residual encoding unit 170, and the spatial information encoding unit 180 and multiplexes the acquired pieces of data. More specifically, the multiplexing unit 190 multiplexes the quantized downmixed signals L″(k, n) and R″(k, n), the quantized residual signals resTTT(k, n), resOTT1(k, n), and resOTT2(k, n), and the quantized spatial information.

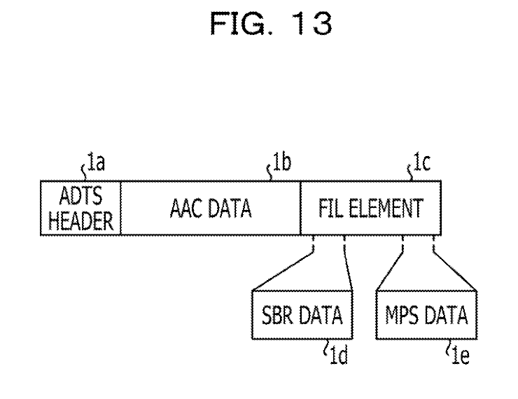

For example, the multiplexing unit 190 uses the MPEG-2 audio data transport stream (ADTS) format as a format of the output data. FIG. 13 is a diagram illustrating an example of the MPEG-2 ADTS format. As illustrated in FIG. 13, the output data includes an ADTS header field 1a, an AAC data field 1b, and an FIL element field 1c.

The AAC data field 1b contains the downmixed signals L″(k, n) and R″(k, n) that have been quantized in accordance with the AAC scheme. The FIL element field 1c includes an SBR data field 1d and an MPS data field 1e. The SBR data field 1d contains the downmixed signals L″(k, n) and R″(k, n) quantized in accordance with the SBR scheme. The MPS data field 1e contains the quantized residual signals and the quantized spatial information. The multiplexing unit 190 outputs the multiplexed data to an external apparatus.

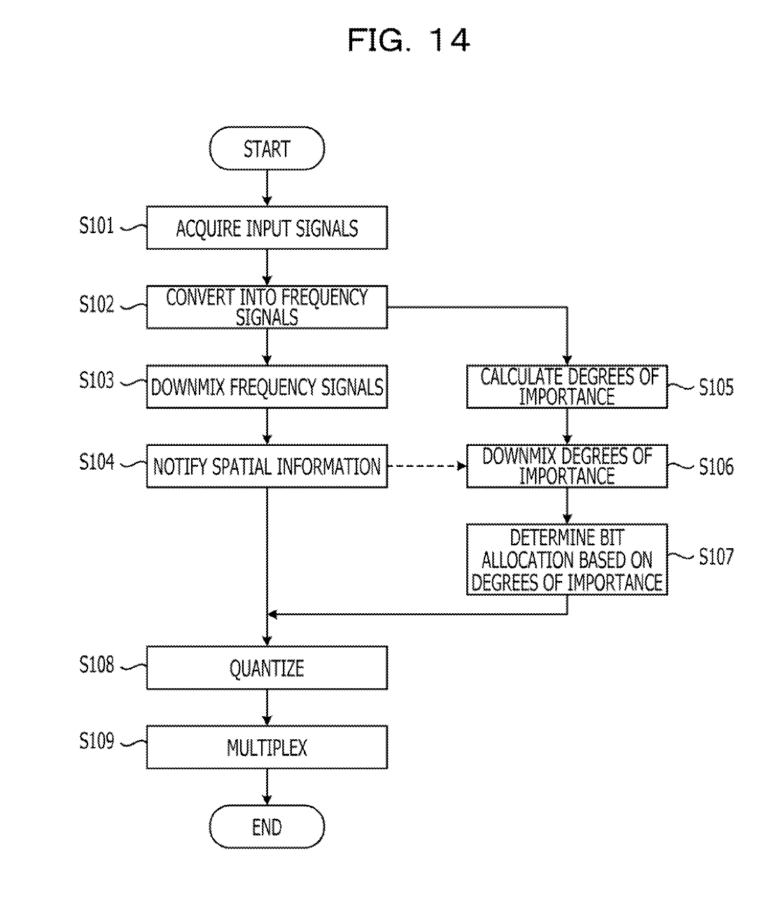

A processing procedure performed by the MPS encoder according to this embodiment will now be described. FIG. 14 is a flowchart illustrating the processing procedure performed by the MPS encoder according to this embodiment. The processing illustrated in FIG. 14 is executed once the MPS encoder 100 acquires input signals, for example. In the flowchart illustrated in FIG. 14, it is assumed that processing of operations S103 and S104 and processing of operations S105 to S107 are executed in parallel. Meanwhile, the processing of operations S105 to S107 may be executed after the processing of operations S103 to S104 is executed.

As illustrated in FIG. 14, after acquiring input signals (operation S101), the time-frequency transforming unit 110 of the MPS encoder 100 transforms the input signals into frequency signals (operation S102). The signal converting unit 120 downmixes the frequency signals (operation S103) and notifies the degree-of-importance converting unit 140 of spatial information (operation S104).

On the other hand, the degree-of-importance calculating unit 130 of the MPS encoder 100 calculates a degree of importance of each frequency signal (operation S105). The degree-of-importance converting unit 140 downmixes the calculated degrees of importance using the spatial information acquired from the signal converting unit 120 (operation S106). The number-of-bits determining unit 150 determines bit allocation based on the downmixed degrees of importance (operation S107).

The core encoding unit 160 and the residual encoding unit 170 quantize the signals in accordance with the bit allocation acquired from the number-of-bits determining unit 150, whereas the spatial information encoding unit 180 quantizes the spatial information (operation S108). The multiplexing unit 190 then multiplexes the quantized signals (operation S109).

Advantages of the MPS encoder 100 according to this embodiment will be described next. The MPS encoder 100 calculates a degree of importance of each signal included in input signals that are to be downmixed. The MPS encoder 100 downmixes the degrees of importance to generate as many degrees of importance as the downmixed input signals and determines bit allocation for use in quantizing the downmixed input signals corresponding to the respective degrees of importance. Since the degrees of importance and the input signals have a one-to-one correspondence before and after downmixing, the bit allocation for each signal included in the input signals can be accurately calculated and unwanted audio quality degradation can be addressed.

Additionally, the MPS encoder 100 downmixes 6-channel frequency signals into 5-channel frequency signals via the R-OTT units 121a to 121c and the R-TTT unit 122. Similarly, the MPS encoder 100 converts six degree-of-importance values into five degree-of-importance values via the R-OTT-P units 141a to 141c and the R-TTT-P unit 142. Since the degrees of importance are downmixed just like the input signals, the degree of importance of each downmixed signal can be determined more appropriately and, thus, the bit allocation appropriate for the signal can be determined.

In addition, the MPS encoder 100 calculates, for each frequency, a difference between masking power and each frequency signal and sums up the determined differences to calculate the degree of importance of the frequency signal. Accordingly, the degree of importance of each frequency signal can be accurately calculated.

Meanwhile, each of the processing units 110 to 190 may correspond to a integrated device, such as an application specific integrated circuit (ASIC) or a field programmable gate array (FPGA). Each of the processing units 110 to 190 may also correspond to an electronic circuit, such as a central processing unit (CPU) or a micro processing unit (MPU).

Meanwhile, each component of the MPS encoder 100 illustrated in FIG. 1 is based on a functional concept and is not necessarily physically configured in a manner illustrated in the figure. That is, concrete forms regarding distribution and integration of the MPS encoder 100 are not limited to the illustrated one and entire or part of the MPS encoder 100 can be functionally or physically configured in a distributed or integrated manner in given units in accordance with various load and usage states. For example, the MPS encoder 100 may include a processing unit that collectively executes the processing of the degree-of-importance calculating unit 130, the degree-of-importance converting unit 140, and the number-of-bits determining unit 150 illustrated in FIG. 1.

Additionally, the MPS encoder 100 can be realized by including each function of the MPS encoder 100 in an available information processing apparatus, such as a personal computer, a workstation, a mobile communication terminal, or a personal digital assistant (PDA).

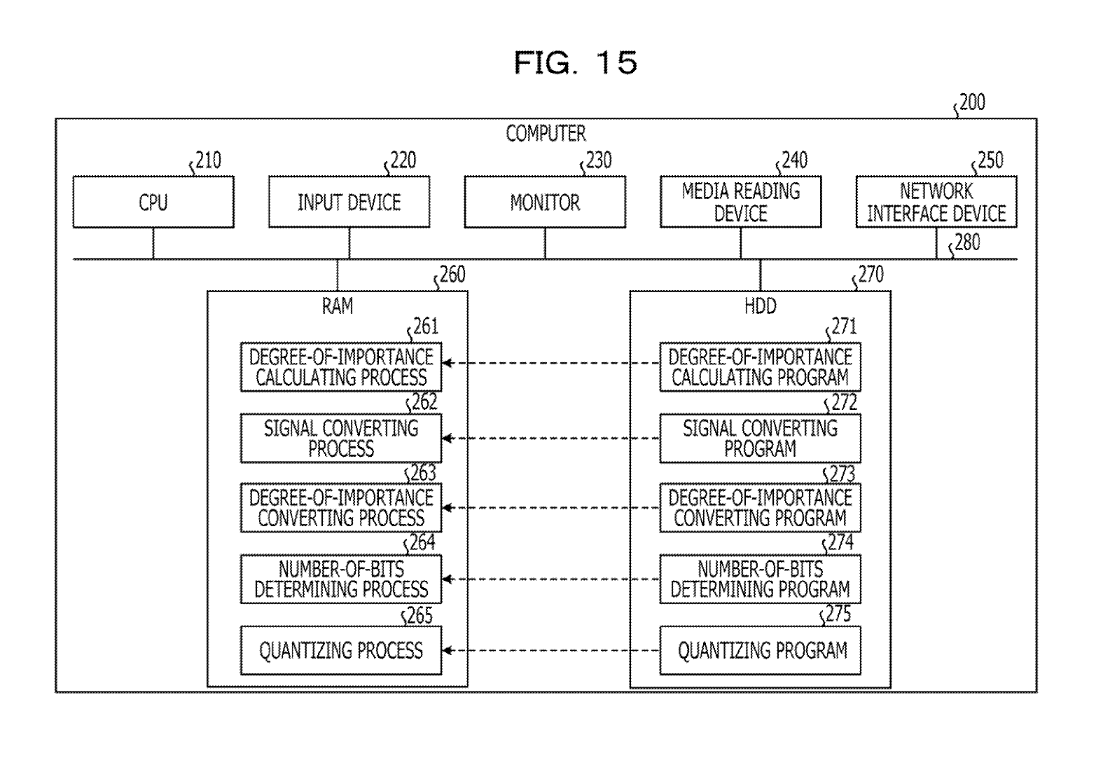

FIG. 15 is a diagram illustrating a hardware configuration of a computer constituting the MPS encoder according to the embodiment. As illustrated in FIG. 15, a computer 200 includes a central processing unit (CPU) 210 that executes various kinds of arithmetic processing, an input device 220 that receives data input from a user, and a monitor 230. The computer 200 also includes a medium reading device 240 that reads out programs or the like from a storage medium and a network interface device 250 that exchanges data with another computer via a network. The computer 200 also includes a random access memory (RAM) 260 that temporarily stores various kinds of information and a hard disk drive (HDD) 270. Each of the devices 210 to 270 is connected to a bus 280.

The HDD 270 stores a degree-of-importance calculating program 271, a signal converting program 272, a degree-of-importance converting program 273, a number-of-bits determining program 274, and a quantizing program 275.

The CPU 210 reads out the programs 271 to 275 stored in the HDD 270 to load the programs in the RAM 260. In this way, the degree-of-importance calculating program 271 functions as a degree-of-importance calculating process 261. The signal converting program 272 functions as a signal converting process 262. The degree-of-importance converting program 273 functions as a degree-of-importance converting process 263. The number-of-bits determining program 274 functions as a number-of-bits determining process 264. The quantizing program 275 functions as a quantizing process 265.

The degree-of-importance calculating process 261 corresponds to the degree-of-importance calculating unit 130 in FIG. 1. The signal converting process 262 corresponds to the signal converting unit 120 in FIG. 1. The degree-of-importance converting process 263 corresponds to the degree-of-importance converting unit 140 in FIG. 1. The number-of-bits determining process 264 corresponds to the number-of-bits determining unit 150 in FIG. 1. The quantizing process 265 corresponds to the core encoding unit 160, the residual encoding unit 170, and the spatial information encoding unit 180 in FIG. 1. Each of the processes 261 to 265 in the RAM 260 executes processing, whereby input signals are quantized.

Meanwhile, the aforementioned programs 271 to 275 are not necessarily stored in the HDD 270. For example, the programs 271 to 275 stored on a storage medium, such as a CD-ROM, may be read out and executed by the computer 200. The programs 271 to 275 may be stored in a storage device connected via a public line, the Internet, a local area network (LAN), and a wide area network (WAN). In this case, the computer 200 may read out and execute these programs 271 to 275 therefrom. However, the computer-readable medium does not include a transitory medium such as a propagation signal.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An encoder comprising:
a degree-of-importance calculating unit that calculates a degree of importance of each of a first number of signals included in input signals;
a signal converting unit that converts the first number of signals included in the input signals into a second number of signals;
a degree-of-importance converting unit that converts a first number of degrees of importance, a number of which is equal to the first number of signals, calculated by the degree-of-importance calculating unit into a second number of degrees of importance, a number of which is equal to the second number of signals;
a number-of-bits determining unit that determines a number of bits for use in quantizing each of the second number of signals obtained by the conversion performed by the signal converting unit based on the second number of degrees of importance obtained by the conversion performed by the degree-of-importance converting unit; and
a quantizing unit that quantizes each of the second number of signals based on a result determined by the number-of-bits determining unit.

2. The encoder according to claim 1,
wherein the degree-of-importance converting unit converts the first number of degrees of importance into the second number of degrees of importance based on spatial information acquired by the signal converting unit.

3. The encoder according to claim 1,
wherein the signal converting unit converts the first number of signals into a given number of signals and converts the given number of signals into the second number of signals, and
wherein the degree-of-importance converting unit converts the first number of degrees of importance into a given number of degrees of importance, a number of which is equal to the given number of signals, and converts the given number of degrees of importance into the second number of degrees of importance.

4. The encoder according to claim 1,
wherein the degree-of-importance calculating unit calculates a degree of importance of an input signal by calculating, for each frequency, a difference between masking power and the input signal and summing the calculated differences.

5. The encoder according to claim 2,
wherein the degree-of-importance calculating unit calculates a degree of importance of an input signal by calculating, for each frequency, a difference between masking power and the input signal and summing the calculated differences.

6. The encoder according to claim 3,
wherein the degree-of-importance calculating unit calculates a degree of importance of an input signal by calculating, for each frequency, a difference between masking power and the input signal and summing the calculated differences.

7. An encoding method executed by a computer, comprising:
calculating, by the computer, a degree of importance of each of a first number of signals included in input signals;
converting a first number of the calculated degrees of importance, a number of which is equal to the first number of signals, into a second number of degrees of importance;
converting the first number of signals included in the input signals into a second number of signals, a number of which is equal to the second number of degrees of importance;
determining a number of bits for use in quantizing each of the second number of signals based on the second number of degrees of importance; and
quantizing each of the second number of signals based on the determined result.

8. The method according to claim 7, further comprising:
converting the first number of signals into a given number of signals and then converting the given number of signals into the second number of signals; and
converting the first number of degrees of importance into a given number of degrees of importance, a number of which is equal to the given number of signals, and then converting the given number of degrees of importance into the second number of degrees of importance.

9. The method according to claim 7,
wherein calculating the degree of importance includes calculating a degree of importance of an input signal by calculating, for each frequency, a difference between masking power and the input signal and summing the calculated differences.

10. The method according to claim 8,
wherein calculating the degree of importance includes calculating a degree of importance of an input signal by calculating, for each frequency, a difference between masking power and the input signal and summing the calculated differences.

11. A computer-readable medium storing an encoding program causing a computer to execute a process, the process comprising:
calculating a degree of importance of each of a first number of signals included in input signals;
converting a first number of the calculated degrees of importance, a number of which is equal to the first number of signals, into a second number of degrees of importance;
converting the first number of signals included in the input signals into a second number of signals, a number of which is equal to the second number of degrees of importance;
determining the number of bits for use in quantizing each of the second number of signals based on the second number of degrees of importance; and
quantizing each of the second number of signals based on the determined result.

12. The computer-readable recording medium according to claim 11, the program causing the computer to execute the process, the process further comprising:
converting the first number of signals into a given number of signals and then converting the given number of signals into the second number of signals; and
converting the first number of degrees of importance into a given number of degrees of importance, a number of which is equal to the given number of signals, and then converting the given number of degrees of importance into the second number of degrees of importance.

13. The computer-readable recording medium according to claim 11,
wherein calculating the degree of importance includes calculating a degree of importance of an input signal by calculating, for each frequency, a difference between masking power and the input signal and summing the calculated differences.

14. The computer-readable recording medium according to claim 12,
wherein calculating the degree of importance includes calculating a degree of importance of an input signal by calculating, for each frequency, a difference between masking power and the input signal and summing the calculated differences.
